(19) United States
(12) Patent Application Publication
(10) Pub. No.: US 2020/0408984 A1
(43) Pub. Date: Dec. 31, 2020

(54) LCD BACKLIGHT UNIT COMPRISING A SOLVENT FREE MICRO-REPLICATION RESIN

(71) Applicant: CORNING INCORPORATED, CORNING, NY (US)

(72) Inventors: Michelle Dawn Fabian, Horseheads, NY (US); Jennifer Lynn Lyon, Painted Post, NY (US); Timothy Edward Myers, Painted Post, NY (US); Kristi Lynn Simonton, Erin, NY (US)

(21) Appl. No.: 16/970,786

(22) PCT Filed: Feb. 19, 2019
(86) PCT No.: PCT/US2019/018549

§ 371 Date: Aug. 18, 2020

Related U.S. Application Data
(60) Provisional application No. 62/632,172, filed on Feb. 19, 2018.

(51) Int. Cl. F21V 8/00

(52) U.S. Cl. CPC G02B 6/0053; G02B 6/0065; G02B 6/0061

(57) ABSTRACT

A backlight unit for use with an LCD display device (10), the backlight unit (24), including a cured polymer layer (34), disposed on a major surface of the glass substrate (28), the cured polymer layer (34) exhibiting a pencil hardness value of 1 H-2 H as measured in accordance with ASTM D3363-05 and an adhesion of 5 B as measured in accordance with ASTM D3359-09. A maximum color shift (Delta) ymax of the cured polymer layer (34) is less than about 0.015 after aging for 1000 hours at 60° C. and 90% relative humidity.

### CROSS-REFERENCE TO RELATED APPLICATIONS

This application claims priority to U.S. Provisional Application Ser. No. 62/632,172 filed on Feb. 19, 2018 the contents of which are relied upon and incorporated herein by reference in their entirety as if fully set forth below.

### FIELD

The present disclosure relates to backlight units for liquid crystal display devices, and more particularly to backlight units comprising a glass light guide plate manufactured using a solvent-free polymer resin for micro-replication of a structured surface on the glass light guide plate.

### BACKGROUND

As demand grows for thinner flat panel displays, such as computer displays, television monitors, and the like, the need arises for thin rigid backlight units (BLU). A typical BLU comprises a light emitting diode (LED) light source, a light guide plate (LGP), a diffusion sheet, two prism sheets (also referred to as brightness enhancing films or BEFs), and a reflecting polarizing film (DBEF). Traditionally, LGPs have been constructed from poly(methyl methacrylate) (PMMA) panels with an extraction pattern printed on or etched into at least one surface of the LGP that allows for a release of light from a light emitting surface of the LGP. PMMA is used for light guide applications due to its transparency and low color shift (Δy), where Δy is the difference in the color emitted from different locations across the LGP.

Without augmentation, the native contrast ratio achievable with an LCD display is the ratio of the brightest portion of an image to the darkest portion of the image. The simplest contrast augmentation occurs by increasing the overall illumination for a bright image, and decreasing the overall illumination for a dark image. Unfortunately, this can lead to muted brights in a dark image, and washed out darks in a bright image. To overcome this limitation, manufacturers can incorporate active local dimming of the image, wherein the illumination within predefined regions of the display panel can be locally dimmed relative to other regions of the display panel, depending on the image being displayed. Such local dimming can be easily incorporated when the light source is positioned directly behind the LCD panel, for example a two-dimensional array of LEDs. However, local dimming is more difficult to incorporate with an edge lighted BLU, wherein an array of LEDs is arranged along an edge of a light guide plate incorporated into the BLU.

Typical BLU's include an LGP into which light is injected via a light source (e.g., an array of light sources), wherein the injected light is guided within the LGP, and then directed outward from the LGP, for example by scattering, toward the LCD panel. To facilitate local diming in edge lighted BLUs, a surface of a light guide plate within the BLU is typically provided with a fine structure to confine the injected light along specific zones with minimal spreading.

PMMA is easily formed, and can be molded or machined to facilitate local dimming. However, PMMA can suffer from thermal degradation, comprises a large coefficient of thermal expansion, suffers from moisture absorption, and is easily deformed.

On the other hand, glass is dimensionally stable (comprises a relatively low coefficient of thermal expansion), and can be produced in large thin sheets suitable for the growing popularity of large, thin TVs. Yet fine surface detail easily molded into plastic (e.g., PMMA) is difficult to form in glass. Accordingly, it would be desirable to produce BLUs that include glass light guide plates capable of facilitating local dimming, such as one dimensional (1D) local dimming, but are easily formable.

### SUMMARY

In accordance with the present disclosure backlight units are disclosed comprising a glass substrate comprising a first major surface and a second major surface opposite the first major surface, a cured polymer layer disposed on the first major surface, the cured polymer layer comprising a pencil hardness value in a range from 1 H to 2 H as measured in accordance with ASTM D3363-05 and an adhesion of 5 B as measured in accordance with ASTM D3359-09, and wherein a maximum color shift Δy_{Cmax} of the cured polymer layer over a wavelength range from 380 nm to 780 nm is equal to or less than about 0.015, for example less than about 0.01, after aging of the cured polymer layer for 1000 hours at 60° C. and 90% relative humidity. The cured polymer layer can comprise a dual-cure polymer material. In various embodiments, the dual-cure polymer material comprises a free radical-curing acrylate and a cationic-curing epoxy.

In some embodiments, the cured polymer layer can comprise a plurality of microstructures. The microstructures can be arranged in rows, for example in parallel rows, such as parallel linear rows.

A thickness of the glass substrate can be in a range from about 0.1 mm to about 3 mm.

A maximum thickness of the cured polymer layer can be in a range from about 10 μm to about 500 μm.

In some embodiments, the glass substrate may further comprise a plurality of light extraction features on the second major surface. A spatial density of the plurality of light extraction features can vary in a length direction of the light guide plate. For example, the spatial density of the plurality of light extraction features can increase in a direction away from a light injection edge surface of the glass substrate.

In some embodiments, the backlight unit may comprise a display device.

In other embodiments, backlight units are described comprising a glass substrate including a first major surface and a second major surface opposite the first major surface;

a cured polymer layer disposed on the first major surface, the cured polymer layer comprising a pencil hardness value in a range from 1 H to 2 H as measured in accordance with ASTM D3363-05 and an adhesion of 5 B as measured in accordance with ASTM D3359-09, the cured polymer layer further comprising a plurality of microstructures arranged in rows, and wherein a maximum color shift Δy_{Cmax} of the cured polymer layer over a wavelength range from 380 nm to 780 nm is equal to or less than about 0.015, for example less than about 0.01, after aging for 1000 hours at 60° C. and 90% relative humidity.

In various embodiments, the cured polymer layer can comprise a dual-cure polymer material. For example, the dual-cure polymer material can comprise a free radical-curing acrylate and a cationic-curing epoxy.

In some embodiments, the second major surface of the glass substrate can comprise a plurality of light extraction features. In some embodiments, a spatial density of the plurality of light extraction features varies in a length direction of the glass substrate. For example, the spatial density of the plurality of light extraction features can increase in a direction away from a light injection edge surface of the glass substrate.

In some embodiments, the backlight unit comprises a display device. For example, the backlight unit may be positioned behind an LCD panel of a display device and used to light the LCD panel. Accordingly, in various embodiments, the backlight unit can comprise a plurality of LEDs positioned proximate a light injection edge surface of the glass substrate.

In some embodiments, a thickness of the glass substrate can be in a range from about 0.1 mm to about 3 mm.

In some embodiments, a maximum thickness of the cured polymer layer can be in a range from about 10 μm to about 500 μm.

In still other embodiments, a light guide plate is disclosed, comprising a glass substrate comprising a first major surface and a second major surface opposite the first major surface, the first major surface comprising a cured polymer layer with a pencil hardness value in a range from 1 H to 2 H as measured in accordance with ASTM D3363-05 and an adhesion to the first major surface of 5 B as measured in accordance with ASTM D3359-09, and wherein a maximum color shift Δy_{Cmax} of the cured polymer layer over a wavelength range from 380 nm to 780 nm is equal to or less than about 0.015 after aging for 1000 hours at 60° C. and 90% relative humidity.

In some embodiments, the second major surface can comprise a plurality of light extraction features. A spatial density of the plurality of light extraction features can vary in a length direction of the light guide plate. For example, the spatial density of the plurality of light extraction features can increase in a direction away from a light injection edge surface of the glass substrate.

In yet other embodiments, display devices are disclosed, the display devices including a backlight unit comprising a glass substrate comprising a first major surface and a second major surface opposite the first major surface, a cured polymer layer disposed on the first major surface, the cured polymer layer comprising a pencil hardness value in a range from 1 H to 2 H as measured in accordance with ASTM D3363-05 and an adhesion of 5 B as measured in accordance with ASTM D3359-09, and wherein a maximum color shift Δy_{Cmax} of the cured polymer layer over a wavelength range from 380 nm to 780 nm is equal to or less than about 0.015, for example less than about 0.01, after aging of the cured polymer layer for 1000 hours at 60° C. and 90% relative humidity. The cured polymer layer can comprise a dual-cure polymer material. In various embodiments, the dual-cure polymer material comprises a free radical-curing acrylate and a cationic-curing epoxy.

In some embodiments, the cured polymer layer can comprise a plurality of microstructures. The microstructures can be arranged in rows, for example in parallel rows, such as parallel linear rows.

A thickness of the glass substrate can be in a range from about 0.1 mm to about 3 mm.

A maximum thickness of the cured polymer layer can be in a range from about 10 μm to about 500 μm.

In some embodiments, the glass substrate may further comprise a plurality of light extraction features on the second major surface. A spatial density of the plurality of light extraction features can vary in a length direction of the light guide plate. For example, the spatial density of the plurality of light extraction features can increase in a direction away from a light injection edge surface of the glass substrate.

In other embodiments, a coating material is described comprising a free radical acrylate monomer, a cationic epoxy monomer, and no more than 0.1% organic solvent.

In embodiments, the coating material is UV curable.

In embodiments, the coating material polymerizes by cationic polymerization and free radial polymerization.

Additional features and advantages of the embodiments disclosed herein will be set forth in the detailed description that follows, and in part will be apparent to those skilled in the art from that description or recognized by practicing the embodiments described herein, including the detailed description which follows, the claims, as well as the appended drawings.

It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure that together with the description serve to explain the principles and operations thereof.

### BRIEF DESCRIPTION OF THE DRAWINGS

FIG. 1 is a cross sectional view of an exemplary display device comprising a BLU;

FIGS. 2A-2C are cross sectional views of exemplary LGPs with different microstructures;

FIG. 3 is a schematic view of an LGP showing dimensional parameters for calculating a local dimming index LDI;

FIG. 4 is a cross sectional view of an exemplary LGP comprising light extraction features;

FIG. 5 is a CIE 1931 color gamut (shown in gray scale) and illustrating two example points A and B for calculating color shift; and

FIG. 6 is a graph comparing color shift data after accelerated aging for bare glass, a solvent-based polymer material and a solvent-free polymer material.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

Light guide plates used in LCD back light applications are typically formed with PMMA, as PMMA exhibits reduced optical absorption compared to many alternative materials. However, PMMA can present certain mechanical drawbacks that make the production of large size (e.g., 32-inch diagonal and greater) displays challenging. Such drawbacks include poor rigidity, high moisture absorption, and a large coefficient of thermal expansion (CTE).

For example, conventional LCD panels are made of two pieces of thin glass (e.g., color filter substrate and TFT backplane substrate), with the BLU comprising a PMMA light guide and a plurality of thin plastic films (diffusers, dual brightness enhancement films (DBEF) films, etc.) positioned behind the LCD panel. Due to the poor elastic modulus of PMMA, the overall structure of the LCD panel exhibits low rigidity, and additional mechanical structure may be necessary to provide stiffness for the LCD panel, thereby adding size and weight to the display device. It should be noted that a Young's modulus of PMMA is generally about 2 gigaPascal (GPa), while certain exemplary glasses can exhibit a Young's modulus ranging from about 60 GPa to 90 GPa or more.

Humidity testing shows that PMMA is sensitive to moisture and can undergo dimensional changes up to about 0.5%. Thus, for a PMMA panel with a length of one meter, a 0.5% change can increase the panel length by up to 5 mm, which is significant and makes the mechanical design of a corresponding BLU challenging. Conventional approaches to solve this problem include leaving an air gap between the LEDs and the PMMA LGP to allow the PMMA LGP to expand. However, light coupling between the LEDs and the LGP is sensitive to the distance from the LEDs to the LGP, and the increased distance can cause display brightness to change as a function of humidity. Moreover, the greater the distance between the LEDs and the LGP, the less efficient the light coupling between the two.

Still further, a CTE of PMMA is about 75×10⁻⁶/° C., and PMMA comprises a low thermal conductivity (approximately 0.2 watts/meter/Kelvin, W/m/K). In comparison, some glasses suitable for use as an LGP can comprise a CTE less than about 8×10⁻⁶/° C. with a thermal conductivity of 0.8 W/m/K or more. Accordingly, glass as a light guiding medium for BLUs offers superior qualities not found in polymer (e.g., PMMA) LGPs.

Additionally, an all-glass light guide exhibits inherently low color shift, does not exhibit polymeric-like aging or “yellowing” under high illumination flux, and can incorporate surface structure designs and uniform total internal reflection (TIR) redirection that enable a reduction in the number of optical components in a display. These attributes are highly desired by customers. Unfortunately, manufacturing all-glass light guide plates configured with very small surface features to facilitate 1D dimming is difficult.

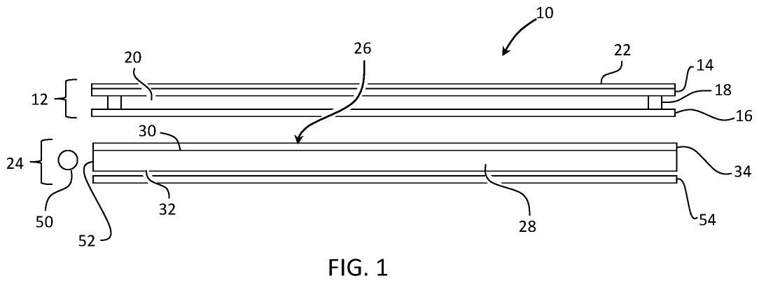

FIG. 1 depicts an exemplary LCD display device 10 comprising an LCD display panel 12 including a first substrate 14 and a second substrate 16 joined by an adhesive material 18 positioned between and around peripheral edge portions of the first and second substrates. First and second substrates 14, 16 are typically glass substrates. First and second substrates 14, 16 and adhesive material 18 form a gap 20 therebetween containing liquid crystal material. Spacers (not shown) may also be used at various locations within gap 20 to maintain consistent spacing of gap 20. First substrate 14 may include color filter material. Accordingly, first substrate 14 may be referred to as the color filter substrate. On the other hand, second substrate 16 can include thin film transistors (TFTs) for controlling the polarization state of the liquid crystal material, and thus may be referred to as the backplane substrate, or simply backplane. LCD panel 12 may further include one or more polarizing filters 22 positioned on a surface thereof.

LCD display device 10 further comprises BLU 24 arranged to illuminate LCD panel 12 from behind, i.e., from the backplane side of the LCD panel. In some embodiments, BLU 24 may be spaced apart from LCD panel 12, although in further embodiments, BLU 24 may be in contact with or coupled to the LCD panel, such as with a transparent adhesive (e.g., a CTE-matched adhesive). BLU 24 includes LGP 26 comprising glass substrate 28 including a first major surface 30, a second major surface 32, and a polymer layer 34 disposed on at least one of first major surface 30 or second major surface 32, although in further embodiments, LGP 26 can include a polymer layer 34 on both first and second major surfaces of glass substrate 28. The polymer layer 34 may be continuous or discontinuous.

BLU 24 may, in some embodiments, further include one or more films or coatings (not shown) deposited on a major surface of glass substrate 28, for example a quantum dot film, a diffusing film, a reflective polarizing film, or a combination thereof

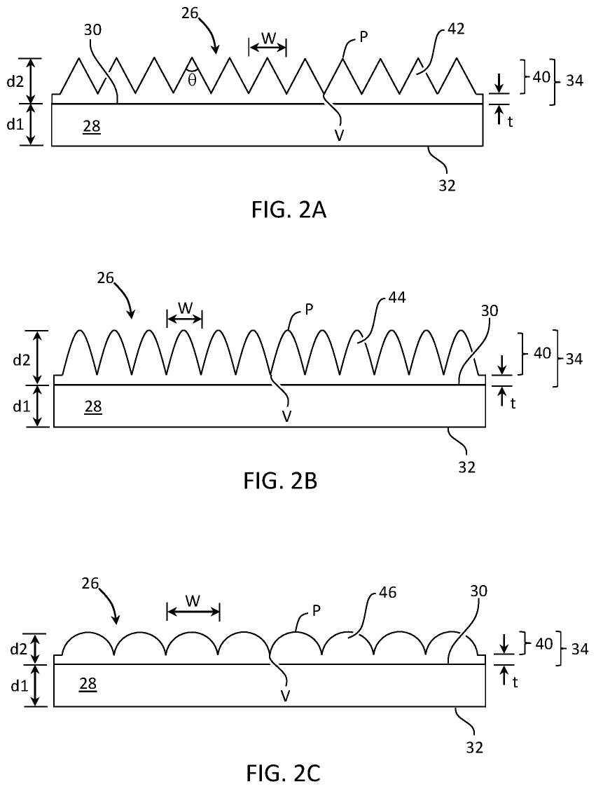

FIGS. 2A 2C are cross sectional views of exemplary LGPs in accordance with embodiments of the present disclosure. As indicated, glass substrate 28 comprises a maximum thickness d1 in a direction orthogonal to and extending between first major surface 30 and second major surface 32. In some embodiments, thickness d1 may be equal to or less than about 3 mm, for example equal to or less than about 2 mm, or equal to or less than about 1 mm, although in further embodiments, thickness d1 may be in a range from about 0.1 mm to about 3 mm, for example in a range from about 0.1 mm to about 2.5 mm, in a range from about 0.3 mm to about 2.1 mm, in a range from about 0.5 mm to about 2.1 mm, in a range from about 0.6 to about 2.1, or in a range from about 0.6 mm to about 1.1 mm, including all ranges and subranges therebetween. The glass substrate 28 can comprise any glass material known in the art for use in display devices. For example, the glass substrate can comprise aluminosilicate, alkali-aluminosilicate, borosilicate, alkali-borosilicate, aluminoborosilicate, alkali-aluminoborosilicate, soda lime, or other suitable glasses.

Non-limiting glass compositions can include between about 50 mol % to about 90 mol % SiO₂, between 0 mol % to about 20 mol % Al₂O₃, between 0 mol % to about 20 mol % B₂O₃, and between 0 mol % to about 25 mol % RₓO, wherein R is any one or more of Li, Na, K, Rb, Cs and x is 2, or Zn, Mg, Ca, Sr or Ba and x is 1. In some embodiments, RₓO—Al₂O₃>0; 0<RₓO—Al₂O₃<15; x=2 and R₂O Al₂O₃<15; R₂O—Al₂O₃<2; x=2 and R₂O—Al₂O₃—MgO>−15; 0<(RₓO—Al₂O₃)<25, −11<(R₂O—Al₂O₃)<11, and −15<(R₂O—Al₂O₃—MgO)<11; and/or −1<(R₂O—Al₂O₃)<2 and −6<(R₂O—Al₂O₃—MgO)<1. In some embodiments, the glass comprises less than 1 ppm each of Co, Ni, and Cr. In some embodiments, the concentration of Fe is <about 50 ppm, <about 20 ppm, or <about 10 ppm. In other embodiments, Fe+30Cr+35Ni<about 60 ppm, Fe+30Cr+35Ni<about 40 ppm, Fe+30Cr+35Ni<about 20 ppm, or Fe+30Cr+35Ni<about 10 ppm. In other embodiments, the glass comprises between about 60 mol % to about 80 mol % SiO₂, between about 0.1 mol % to about 15 mol % Al₂O₃, 0 mol % to about 12 mol % B₂O₃, and about 0.1 mol % to about 15 mol % R₂O and about 0.1 mol % to about 15 mol % RO, wherein R is any one or more of Li, Na, K, Rb, Cs and x is 2, or Zn, Mg, Ca, Sr or Ba and x is 1.

In other embodiments, the glass composition can comprise between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂.

In additional embodiments, the glass substrate 28 can comprise an RₓO/Al₂O₃ ratio between 0.95 and 3.23, wherein R is any one or more of Li, Na, K, Rb, Cs and x is 2. In further embodiments, the glass substrate may comprise an RₓO/Al₂O₃ ratio between 1.18 and 5.68, wherein R is any one or more of Li, Na, K, Rb, Cs and x is 2, or Zn, Mg, Ca, Sr or Ba and x is 1. In yet further embodiments, the glass substrate can comprise an RₓO Al₂O₃ MgO between −4.25 and 4.0, wherein R is any one or more of Li, Na, K, Rb, Cs and x is 2.

In still further embodiments, the glass substrate may comprise between about 66 mol % to about 78 mol % SiO₂, between about 4 mol % to about 11 mol % Al₂O₃, between about 4 mol % to about 11 mol % B₂O₃, between about 0 mol % to about 2 mol % Li2O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂.

In additional embodiments, the glass substrate 28 can comprise between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In certain embodiments, the glass substrate can comprise between about 60 mol % to about 80 mol % SiO₂, between about 0 mol % to about 15 mol % Al₂O₃, between about 0 mol % to about 15 mol % B₂O₃, and about 2 mol % to about 50 mol % RₓO , wherein R is any one or more of Li, Na, K, Rb, Cs and x is 2, or Zn, Mg, Ca, Sr or Ba and x is 1, and wherein Fe+30Cr+35Ni<about 60 ppm. Suitable commercial glasses can include, for instance, EAGLE XG®, Lotus™, Willow®, Iris™, and Gorilla® glasses from Corning Incorporated.

It should be understood, however, that embodiments described herein are not limited by glass composition, and the foregoing compositional embodiments are not limiting in that regard.

In some embodiments, glass substrate 28 can exhibit a maximum color shift Δy_{Gmax} over a wavelength range of 380 nm to 7807 nm less than 0.015, such as in a range from about 0.005 to about 0.015, for example in a range from about 0.006 to about 0.015, in a range from about 0.007 to about 0.015, in a range from about 0.008 to about 0.015, in a range from about 0.009 to about 0.015, in a range from about 0.010 to about 0.015, in a range from about 0.011 to about 0.015, in a range from about 0.012 to about 0.015, in a range from about 0.013 to about 0.015, in a range from about 0.014 to about 0.015, in a range from about 0.05 to about 0.014, in a range from about 0.05 to about 0.013, in a range from about 0.005 to about 0.012, in a range from about 0.005 to about 0.011, in a range from about 0.005 to about 0.010, in a range from about 0.005 to about 0.009, in a range from about 0.005 to about 0.008, in a range from about 0.005 to about 0.007, or a range from about 0.005 to about 0.006, including all ranges and subranges therebetween.

According to certain embodiments, the glass substrate can have a light attenuation al (e.g., due to absorption and/or scattering losses) of less than about 4 dB/m, such as less than about 3 dB/m, less than about 2 dB/m, less than about 1 dB/m, less than about 0.5 dB/m, less than about 0.2 dB/m, or even less. For example, light attenuation al can be in a range from about 0.2 dB/m to about 4 dB/m for wavelengths ranging from about 420-750 nm.

The glass substrate 28 may, in some embodiments, be chemically strengthened, e.g., by ion exchange. During the ion exchange process, ions within a glass substrate at or near the surface of the glass substrate may be exchanged for larger ions, for example, from a salt bath. The incorporation of the larger ions into the glass surface can strengthen the substrate by creating a compressive stress in a near surface region of the substrate. A corresponding tensile stress can be induced within a central region of the glass substrate to balance the compressive stress.

Ion exchange may be carried out, for example, by immersing the glass substrate in a molten salt bath for a predetermined period of time. Exemplary salt baths include, but are not limited to, KNO₃, LiNO₃, NaNO₃, RbNO₃, or combinations thereof. The temperature of the molten salt bath and treatment time period can vary. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer that imparts a surface compressive stress.

Glass substrate 28 can have any desired size and/or shape as appropriate to produce a desired light distribution. First and second major surfaces 30, 32 may, in certain embodiments, be planar or substantially planar, e.g., substantially flat. First and second major surfaces 30, 32 may, in various embodiments, be parallel or substantially parallel, although in further embodiments, first and second major surfaces 30, 32 may be non-parallel. The glass substrate 28 may comprise four edges, or may comprise more than four edges, e.g. a multi-sided polygon. In other embodiments, the glass substrate 28 may comprise less than four edges, e.g., a triangle. By way of a non-limiting example, the light guide may comprise a rectangular, square, or rhomboid substrate having four edges, although other shapes and configurations are intended to fall within the scope of the disclosure including those having one or more curvilinear portions or edges.

Still referring to FIGS. 2A-2C, the illustrated LGPs can include a polymer layer 34 comprising microstructures 40 disposed on a major surface of glass substrate 28 arranged as an array comprising rows of microstructures. For example, in various embodiments the rows of microstructures 40 can be linear rows of microstructures, such as parallel rows of microstructures. Microstructures 40 can, for example, comprise peaked prisms 42 or rounded prisms 44, respectively, as shown in FIGS. 2A-2B. However, as shown in FIG. 2C, microstructures 40 can also comprise lenticular (e.g., cylindrical) lenses 46. Of course, the depicted microstructures are exemplary only and are not intended to limit the appended claims. Other microstructure shapes are possible and intended to fall within the scope of the present disclosure. For example, while FIGS. 2A-2C illustrate regularly (or periodically) occurring rows, it is also possible to use irregular (non-periodic) rows.

As used herein, the terms “microstructures,” “microstructured,” and variations thereof are intended to refer to surface relief features of the polymer layer having at least one of height, width or length that is less than about 500 such as less than about 400 less than about 300 less than about 200 less than about 100 less than about 50 or even less, for example in a range from about 10 μm to about 500 μm, in a range from about 10 μm to about 450 μm, in a range from about 10 μm to about 400 μm, in a range from about 10 μm to about 350 μm, in a range from about 10 μm to about 300 μm, in a range from about 10 μm to about 250 μm, in a range from about 10 μm to about 200 μm, in a range from about 10 μm to about 150 μm, in a range from about 10 μm to about 100 μm, in a range from about 10 μm to about 50 μm, in a range from about 10 μm to about 20 μm, in a range from about 20 μm to about 500 μm, in a range from about 50 μm to about 500 μm, in a range from about 100 μm to about 500 μm, in a range from about 150 μm to about 500 μm, in a range from about 200 μm to about 500 μm, in a range from about 250 μm to about 500 μm, in a range from about 300 μm to about 500 μm, in a range from about 300 μm to about 500 μm, in a range from about 350 μm to about 500 μm, in a range from about 400 μm to about 500 μm, or in a range from about 4500 μm to about 500 μm, including all ranges and subranges therebetween.

Microstructures 40 may, in certain embodiments, have regular or irregular cross-sectional shapes, which can be identical, or different, within a given row, or between rows. While FIGS. 2A-2C generally illustrate microstructures 40 of the same size and shape evenly spaced apart at substantially the same pitch (periodicity), it is to be understood that not all microstructures may have the same size and/or shape and/or spacing. Combinations of microstructure shapes and/or sizes may be used, and such combinations may be arranged in a periodic or non-periodic fashion.

Moreover, the size and/or shape of the microstructures 40 can be varied depending on the desired light output and/or optical functionality of the LGP. For instance, different microstructure shapes may result in different local dimming efficiencies, also referred to as the local dimming index (LDI).

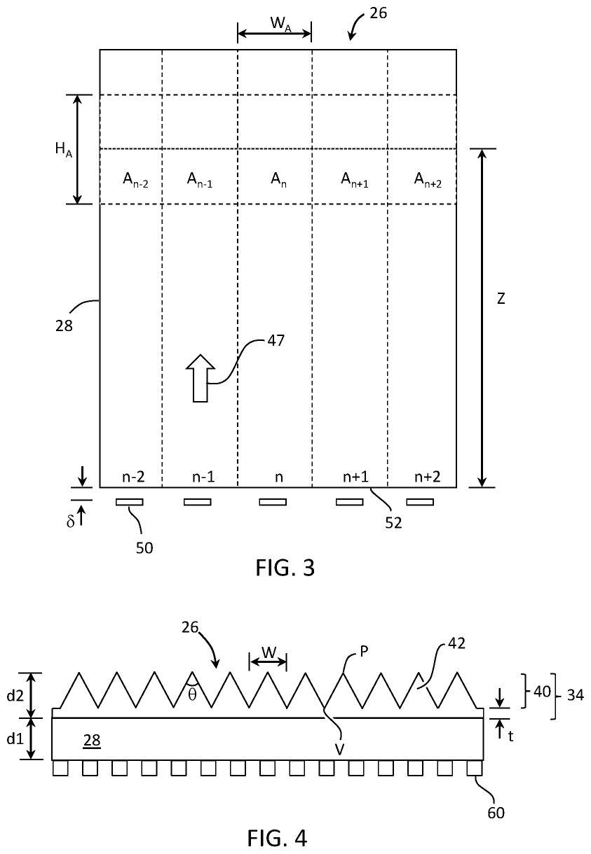

As shown in FIG. 3, LDI at a distance Z from a light injection edge surface 52 can be defined as:

$$LDI = [ 1 - \frac{( {L}_{n + 1} + {L}_{n - 1} ) / 2}{{L}_{n}} ] \times 100 \qquad ( 1 )$$

where Lₘ is the luminance of the area Aₘ of zone m (m=n−2, n−1, n, n+1, n+2) at a distance Z from LED light injection edge surface 52. Each area Aₘ can be defined by a width WA and a height H_{A}. LDI is a function of the luminance of zones of an LGP. As a practical matter, LDI is a measure of the degree of confinement of light injected into a given lighting zone of the LGP, i.e., how much light is retained within that lighting zone. The larger the magnitude of LDI, the better the light confinement performance of the LGP (more light confined within the light-injected zone).

By way of non-limiting example, a periodic array of prism microstructures may result in an LDI value up to about 70%, whereas a periodic array of lenticular lenses may result in an LDI value up to about 83%. The microstructure size and/or shape and/or spacing may be varied to achieve different LDI values. Different microstructure shapes may also provide additional optical functionalities. For instance, a peaked prism array of microstructures having a 90° prism angle may not only result in more efficient local dimming, but may also partially focus the light in a direction perpendicular to the prismatic ridges due to recycling and redirecting of the light rays. In some embodiments, both major surfaces of glass substrate 28 may include a polymer layer with microstructures.

With reference to FIG. 2A, the peaked prism microstructures 42 can have a prism angle θ in a range from about 60° to about 120°, such as in a range from about 70° to about 110°, in a range from about 80° to about 100°, or in a range from about 90° to about 100°, including all ranges and subranges therebetween. Referring to FIG. 2C, the lenticular lens microstructures 46 can have any given cross-sectional shape, ranging from semi-circular, semi-elliptical, parabolic, or other similar curved shapes.

Referring again to FIG. 1, BLU 24 further comprises at least one light source, for example a light emitting diode (LED) 50 or an array of light emitting diodes (LEDs) 50 arranged along at least one light injection edge surface 52 of glass substrate 28 and optically coupled thereto, e.g., positioned adjacent to light injection edge surface 52. As used herein, the term “optically coupled” is intended to denote that a light source is positioned adjacent a light injection edge surface of the LGP so as to introduce light into the LGP. A light source may be optically coupled to the LGP even though it is not in physical contact with the LGP. Additional light sources (not illustrated) may also be optically coupled to other edge surfaces of the LGP, such as adjacent or opposing edge surfaces.

In some embodiments, LEDs 50 may be located a distance 6 from light injection edge surface 52, for example less than about 0.5 mm. According to one or more embodiments, LEDs 50 may comprise a thickness (height) less than or equal to thickness d1 of glass substrate 28 to provide efficient light coupling into the glass substrate.

Light emitted by the at least one light source is injected through the at least one light injection edge surface 52 and guided through glass substrate 28 by total internal reflection, and extracted to illuminate LCD panel 12, for example by extraction features on one or both of first and second major surfaces 30, 32 of glass substrate 28, polymer layer 34, or within the bulk (body) of the glass substrate.

Light injected into the LGP may propagate along a length of the LGP due to total internal reflection (TIR) until it strikes an interface at an angle of incidence less than the critical angle. Total internal reflection (TIR) is the phenomenon by which light propagating in a first material (e.g., glass, plastic, etc.) comprising a first refractive index can be totally reflected at the interface with a second material (e.g., air, etc.) comprising a second refractive index lower than the first refractive index. TIR can be explained using Snell's law:

n₁ sin(σᵢ)=n₂ sin(σᵣ) (2)

which describes the refraction of light at an interface between two materials of differing indices of refraction. In accordance with Snell's law, n₁ is the refractive index of a first material, n₂ is the refractive index of a second material, σᵢ is the angle of the light incident at the interface relative to a normal to the interface (incident angle), and σᵣ is the angle of refraction of the refracted light relative to the normal. When the angle of refraction σᵣ is 90°, e.g., sin(σᵣ)=1, Snell's law can be expressed as:

σ_{c}=σᵢ=sin⁻¹(n₂/n₁) (3)

The incident angle σᵢ under these conditions may also be referred to as the critical angle σ_{c}. Light having an incident angle greater than the critical angle (σᵢ>σ_{c}) will be totally internally reflected within the first material, whereas light with an incident angle equal to or less than the critical angle ((σᵢ≤σ_{c}) will be transmitted by the first material.

In the case of an exemplary interface between air (n₁=1) and glass (n₂=1.5), the critical angle (σ_{c}) can be calculated as 41°. Thus, if light propagating in the glass strikes the air-glass interface at an incident angle greater than 41°, all the incident light will be reflected from the interface at an angle equal to the incident angle. If the reflected light encounters a second interface comprising an identical refractive index relationship as the first interface, the light incident on the second interface will again be reflected at a reflection angle equal to the incident angle.

Extraction features can disrupt the total internal reflection and cause light propagating within glass substrate 28 to be directed out of the glass substrate through one or both of major surfaces 30, 32. Thus, in some embodiments, BLU 24 may further include a reflector plate 54 positioned behind LGP 26, opposite LCD panel 12, to redirect light extracted from the back side of glass substrate 28, e.g., major surface 32, to a forward direction through first major surface 30 and toward LCD panel 12.

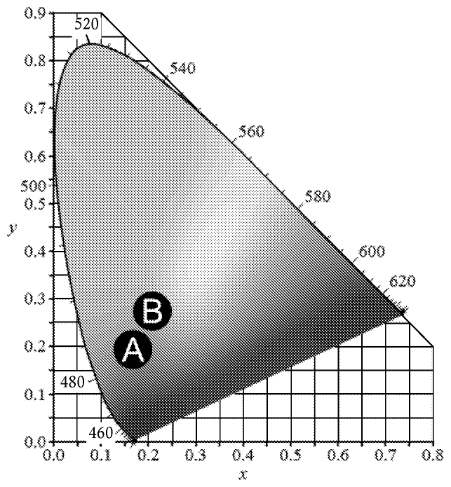

As illustrated in FIG. 4, in various embodiments, the second major surface 32 of the glass substrate 28 can be patterned with a plurality of light extraction features 60. As used herein, the term “patterned” is intended to denote that the plurality of light extraction features is present on or in the surface of the substrate in any predetermined pattern or design, which may, for example, be random or arranged, repetitive or non-repetitive, uniform or non-uniform. In other embodiments, the light extraction features may be located within the body of the glass substrate adjacent the surface, e.g., below the surface. For instance, the light extraction features may be distributed across the surface, e.g., as textural features making up a roughened or raised surface, or may be distributed within and throughout the substrate or portions thereof, e.g., as laser-damaged features. Suitable methods for creating such light extraction features can include printing, such as inkjet printing, screen printing, microprinting, and the like, texturing, mechanical roughening, etching, injection molding, coating, laser damaging, or any combination thereof. Non-limiting examples of such methods can include, for instance, acid etching a surface, coating a surface with TiO2, and laser damaging the substrate by focusing a laser on a surface of the substrate or within the substrate body. In still other embodiments, the light extraction features may be present on a surface of the polymer layer 34.

According to various embodiments, extraction features 60 may be patterned at a density suitable to produce substantially uniform light output intensity across the light emitting surface of the glass substrate, e.g., major surface 30. In certain embodiments, a spatial density of the light extraction features proximate the light source, e.g., at light injection edge surface 52, may be lower than a spatial density of the light extraction features at a point farther removed from the light source, at the opposite edge of the LGP, or vice versa, such as exhibiting a gradient from one edge of the substrate to an opposite edge of the substrate, as appropriate to create the desired light output distribution across the LGP.

The LGP can be treated to form light extraction features according to any method known in the art, e.g., the methods disclosed in co-pending and co-owned International Patent Application Nos. PCT/US2013/063622 and PCT/US2014/070771, each incorporated herein by reference in their entirety. For example, a surface of the LGP may be ground and/or polished to achieve the desired thickness and/or surface quality. The surface may then be optionally cleaned, or the surface to be etched may be subjected to a process for removing contamination, such as exposing the surface to ozone. The surface to be etched may, by way of a non-limiting embodiment, be exposed to an acid bath, e.g., a mixture of glacial acetic acid (GAA) and ammonium fluoride (NH₄F) in a ratio ranging from about 1:1 to about 9:1. The etching time may range, for example, from about 30 seconds to about 15 minutes, and the etching may take place at room temperature or at an elevated temperature. Process parameters such as acid concentration, temperature, and/or time may affect the size, shape, and distribution of the resulting extraction features.

In certain embodiments, LGP 26 can be configured such that it is possible to achieve 2D local dimming. For instance, one or more additional light sources can be optically coupled to an adjacent (e.g., orthogonal) light injection edge surface. A first polymer layer can be arranged on the light emitting surface of the glass substrate, the first polymer layer having microstructures extending in a light propagation direction, and a second polymer layer may be arranged on the opposing major surface of the glass substrate, the second polymer layer having microstructures extending in a direction orthogonal to the light propagation direction. Thus, 2D local dimming may be achieved by selectively shutting off one or more of the light sources along each light injection edge surface.

In accordance with embodiments described herein, polymer layer 34 can comprise a dual-cure polymer material comprising a blended composition of one or more UV-curable acrylate materials and one or more epoxy materials, such as one or more free-radical-cured acrylate materials and one or more cationic-cured epoxy materials. The polymer material may further be chosen from compositions having a low color shift and/or low absorption of blue light wavelengths (e.g., 450 nm-500 nm) when cured, as discussed in more detail below. In certain embodiments, the polymer layer 34 may be thinly deposited on the light emitting surface of the glass substrate (the surface facing LCD panel 12).

Returning to FIGS. 2A-2C, the array of microstructures 40 may comprise peaks P and valleys V, the maximum thickness d2 of polymer layer 34 can correspond to the height of the peaks P above a surface of the glass substrate on which the polymer layer is deposited (e.g., first major surface 30), and the minimum thickness t of polymer layer 34 can correspond to the height of the valleys V above the surface of the glass substrate on which the polymer layer is deposited. According to various embodiments, polymer layer 34 can be deposited such that the minimum thickness t is zero or as close to zero as possible. When t is zero, polymer layer 34 may be discontinuous. For instance, the minimum thickness t may be in a range from 0 to about 250 μm, such as in a range from about 10 μm to about 200 μm, in a range from about 20 μm to about 150 μm, or in a range from about 50 μm to about 100 μm, including all ranges and subranges therebetween. In additional embodiments, the maximum thickness d2 can be in a range from about 10 μm to about 500 μm, such as in a range from about 20 μm to about 400 μm, in a range from about 30 μm to about 300 μm, in a range from about 40 μm to about 200 μm, or in a range from about 50 μm to about 100 μm, including all ranges and subranges therebetween.

With continued reference to FIGS. 2A-2C, microstructures 40 also have a width W, which can be varied as desired to achieve a desired light output. Accordingly, in some embodiments, the width W and/or maximum thickness d2 may be varied to obtain a desired aspect ratio. Variation of the minimum thickness t can also be used to modify light output from the LGP. In non-limiting embodiments, the aspect ratio W/(d2−t) of the microstructures 40 can range from about 0.1 to about 3, such as from about 0.5 to about 2.5, from about 1 to about 2.2, or from about 1.5 to about 2, including all ranges and subranges therebetween. According to some embodiments, the aspect ratio can range from about 2 to about 3, e.g., about 2, 2.1, 2.2, 2.3, 2.4, 2.5, 2.6, 2.7, 2.8, 2.9, or 3, including all ranges and subranges therebetween. The width W of microstructures 40 can range, for example, from about 1 μm to about 250 μm, such as from about 10 μm to about 200 μm, from about 20 μm to about 150 μm, or from about 50 μm to about 100 μm, including all ranges and subranges therebetween. It should also be noted that microstructures 40 may have a length (not labeled) extending in the direction of light propagation (see arrow 47 in FIG. 3) that can vary as desired, e.g., depending on the length of glass substrate 28.

Polymer layer 34 can, in certain embodiments, comprise a material that does not exhibit a noticeable color shift, particularly after aging. Several plastics and resins can have a tendency to develop a yellow tint over time due to light absorption of blue wavelengths (e.g., from about 450 nm to about 500 nm). This discoloration may worsen at elevated temperatures, for instance, within normal BLU operating temperatures. Moreover, BLUs incorporating LED light sources can exacerbate the color shift due to significant emission of blue wavelengths. In particular, LEDs can be used to deliver white light by coating a blue-emitting LED with a color converting material (such as phosphors, etc.) that converts some of the blue light to red and green wavelengths, resulting in an overall perception of white light. However, despite this color conversion, the LED emission spectrum can still have a strong emission peak in the blue region. If the polymer layer 34 absorbs the blue light, it may be converted to heat, thereby further accelerating polymer degradation and further increasing blue light absorption over time.

While absorption of blue light by the polymer layer 34 may be negligible when light propagates perpendicular to the layer, it can be more significant when light propagates along the length of the polymer layer (as in the case of an edge-lighted LGP) due to the longer propagation length. Blue light absorption along the length of the LGP can result in a noticeable loss of blue light intensity and a noticeable change of color (e.g., a yellow color shift) along the propagation direction. As such, a color shift Δy may be perceived by the human eye from one edge of the display to the other. As described herein, color shift is an optical measurement of the difference in the color emitted from different locations, an upstream location A and a downstream position B (relative to the direction of light propagation) across an LGP as light is guided along a length or width of the LGP, bouncing numerous times through both glass and the resin coating. The color shift of a light guide plate is evaluated using a standard CIE 1931 color space (represented in gray scale in FIG. 5), and is calculated as the difference in y-value between the upstream A position and the downstream B position, y_{A}-y_{B}.

Accordingly, a polymer material should be selected for polymer layer 34 that has comparable absorption values for different wavelengths within the visible range (e.g., 420 nm-750 nm). For instance, the absorption at blue wavelengths may be substantially similar to the absorption at red wavelengths, and so forth.

One approach for producing a glass LGP with a microstructured surface is to laminate a polymer film onto the glass surface using an optical adhesive. However, the lamination approach results in a thicker overall LGP due to the presence of both the polymer film and an optical adhesive to attach the film to the glass. The use of additional layers also increases the potential for high color shift, particularly after aging.

To overcome these limitations, a micro-replication approach can be employed. Micro-replication is a method by which a desired pattern comprising a plurality of microstructures can be embossed into the surface of a polymer sheet. In accordance with embodiments disclosed herein, a thin polymer layer 34 can be deposited onto glass substrate 28 and subsequently patterned by exposure to UV light in a molding step.

One approach for producing a resin for micro-replication of microstructure features is to dissolve PMMA polymer in a solvent and add a UV curable cross-linking monomer to facilitate the formation of the microstructure features in the micro-replication process. However, this approach requires a high solvent content (e.g., 60-70%) to reduce the viscosity to a level needed to be compatible with a slot-die coating process used to apply coating to the glass prior to micro-replication. The solvent must be removed in a subsequent process step prior to the molding step. For example, removal of the solvent, such as by evaporation, requires expensive specialized equipment to remove the solvent safely and adds an additional step to the process. Also high solvent content may impede moving such a process into production facilities in certain countries.

A solvent-free polymer resin eliminates a drying step prior to molding and addresses safety concerns (e.g., fire, explosion and inhalation issues) associated with the use of high levels of solvent. By solvent-free what is meant is that the polymer resin before cure comprises no more than about 0.1% organic solvent, for example 0% methyl ethyl ketone (MEK) and less than about 0.1% toluene. The cured resin layer exhibits high hardness and strong adhesion to the glass, and produces minimal color-shift after accelerated aging for 1000 hours at 60° C. and 90% relative humidity (RH). The resin formulation should, prior to curing, be in a viscosity range that makes it compatible with both a coating application step and a UV molding step.

Exemplary embodiments disclosed herein describe an acrylate and epoxy monomer-based blended coating that, after curing, exhibits very low color shift when compared to other polymer resins upon accelerated aging at 60° C. and 90% relative humidity for 1000 hours. Exemplary cured polymer layers described herein further exhibit a pencil hardness value in a range from 1 H to 2 H as defined by ASTM D3363-05 and an adhesion of 5 B as defined by ASTM D3359-09. A ratio of the total concentration of epoxy material to acrylate material within the polymer composition can be 50%:50%±5%. That is, the concentration of epoxy material and the concentration of acrylate material in certain embodiments should not differ by more than 5%. For example, the total concentration of all epoxy materials can be 55% by weight and the total concentration of acrylate material can then be no less than 50%, and vice versa.

The color shift of such polymer resins does not significantly increase upon aging. For example, the maximum color shift Δy_{Cmax} of exemplary glass-polymer LGPs disclosed herein over a wavelength range from 380 nm to 780 nm is equal to or less than about 0.015, for example in a range from about 0.006 to about 0.015, in a range from about 0.007 to about 0.015, in a range from about 0.008 to about 0.015, in a range from about 0.009 to about 0.015, in a range from about 0.010 to about 0.015, in a range from ab out 0.011 to about 0.015, in a range from about 0.012 to about 0.015, in a range from about 0.013 to about 0.015, in a range from about 0.014 to about 0.015, in a range from about 0.05 to about 0.014, in a range from about 0.05 to about 0.013, in a range from about 0.005 to about 0.012, in a range from about 0.005 to about 0.011, in a range from about 0.005 to about 0.010, in a range from about 0.005 to about 0.009, in a range from about 0.005 to about 0.008, in a range from about 0.005 to about 0.007, or a range from about 0.005 to about 0.006, including all ranges and subranges therebetween.

Table 1 below discloses individual components of an exemplary blended composition “A” of such a dual-cure polymer resin, including, from left to right, the component amount in weight percent (wt %), the material (e.g., source and commercial name), and the component name. As used herein, a “dual-cure” polymer resin refers to a blended polymer resin material embodying two different polymerization mechanisms; e.g., cationic polymerization and free radical polymerization. During free-radical polymerization a free-radical is transferred from monomer to monomer during chain growth, while during cationic polymerization a charge is transferred from monomer to monomer during chain growth.

TABLE 1

| wt % | Material | Chemical Name |
|---|---|---|
| 36 | Synasia S06E | 3,4-Epoxycyclohexylmethyl-3′,4′- |
| | | epoxycyclohexane carboxylate |
| 11.2 | Perstorp | Trimethylolpropane oxetane |
| | Curalite OX | |
| 0.75 | Synasia PI-6976 | triarylsulfonium hexafluoroantimonate salts |
| | | in propylene carbonate |
| 0.25 | Tego glide 100 | Polyeither siloxane copolymer |
| 1.75 | Silquest A-186 | Epoxy functionalized silane |
| 35.1 | Miramer M200 | Hexanediol diacrylate |
| 14.3 | IBOA M1140 | Isobornyl acrylate |
| 0.50 | Speedcure 1173 | 2-hydroxy-2-methyl-propiophenone |
| 0.05 | Irganox 1010 | Antioxidant |
| 0.10 | blue tint | 0.01% BASF Oracet ®Blue in toluene |

Comparative examples are provided in Table 2 (composition “B”) and Table 3 (Composition “C”): a free radical curing acrylate and a cationic curing epoxy, respectively. Although samples B and C are solvent-free, they nevertheless failed to provide adequate adhesion or exhibited excessive color shift, respectively.

TABLE 2

| wt % | Material | Chemical name |
|---|---|---|
| 70.25 | Miramer M200 | Hexanediol diacrylate |
| 28.65 | Miramer M1140 | Isobornyl acrylate |
| 1.00 | Speedcure 1173 | 2-hydroxy-2-methyl-propiophenone |
| 0.10 | Irganox 1010 | antioxidant |
| 72.27 | Synasia S06E | 3,4-Epoxycyclohexylmethyl-3′,4′- |
| | | epoxycyclohexane carboxylate |
| 22.53 | Perstorp | Trimethylolpropane oxetane |
| | Curalite OX | |
| 1.50 | Synasia PI-6976 | triarylsulfonium hexafluoroantimonate salts |
| | | in propylene carbonate |
| 3.50 | Silquest A-186 | Epoxy functionalized silane |
| 0.20 | Silwet L-7604 | silicone |

### Table 3

The process to make the samples for color shift testing was as follows. The polymer resin material of Table 1 and the comparative resins from Tables 2 and 3 were applied to glass plates using a slot-die coater. The coating layer thickness for each sample was 25 μm. The coating was cured using a Phoseon Technology FirePower™ FP300 225×20WC365-12W lamp at 100% power, and which delivered 5273 mJ/cm² and 8202 mW/cm² at a wavelength of 365 nm to the coated sample. The dose was measured using radiometer EIT UV Power Puck II Version 4.03 Standard 10 W range (with an approximately cosine spatial response). After UV cure, the samples were thermally baked for 15 minutes at 115° C. The samples were then patterned with a Coherent GEM100LDE CO₂ laser at a wavelength of 10.6 μm with a maximum continuous wave (CW) laser power of about 60 watts and an unfocused beam width of about 5 mm to create an extraction pattern on the glass surface opposite to the polymer layer (e.g., second major surface 32).

To measure color shift, light from an LED strip was launched into an edge surface of the polymer-coated and patterned glass sample. Two diffuser films (bottom and top) and a BEF prism sheet were layered on top of the cured polymer resin layer such that the bottom diffuser film was in contact with the polymer resin layer and the BEF film was in-between diffusers, with the top diffuser farthest away from the polymer resin layer. A SpectraScan® Spectroradiometer 670, placed above the top diffuser film, took measurements across the 320 mm length sample. The spectraScan 670 measures across a wavelength range of 380 nm to 780 nm. SpectraWin® software was used to control the camera and compile data.

To evaluate compatibility with micro-replication, the polymer resin was applied to a glass substrate using a 1 mil bird application bar. A transparent lenticular mold made from polyethylene terephthalate (PET) was then applied by hand to the coating surface. The coating received the same UV cure described above. If the mold removed cleanly with no material adhering to the mold, and the resultant microstructures in the polymer layer appeared to be intact when viewed at 20× magnification, the coating was deemed compatible with a micro-replication process.

Table 4 below presents a summary of data collected for both the coating “A” and comparative coatings “B” and “C”. The pencil hardness values were generated using ASTM D3363-05. Adhesion to glass was measured by crosshatch adhesion testing as described by ASTM D3359-09. Maximum color shift Δy_{Cmax} is reported after 1000 hours at 60° C. and 90% relative humidity accelerated aging.

TABLE 4

| | Epoxy-Acrylate | Comparative | Comparative |
|---|---|---|---|
| Attribute | (A) | acrylate (B) | epoxy (C) |
| Adhesion to glass | 5B | 0B | 5B |
| Pencil hardness | 1H-2H | 1H | 2H |
| Color shift Δy_{Cmax} | 0.010 | 0.013 | 0.016 |
| after aging | | | |

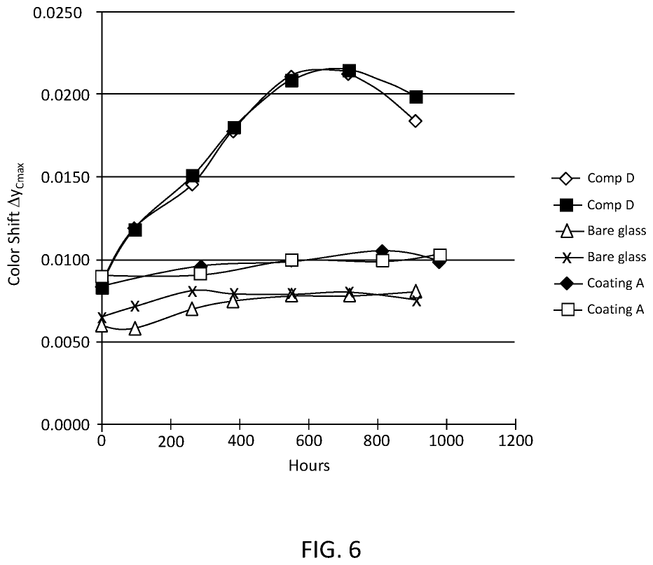

FIG. 6 is a graph comparing the maximum color shift of bare glass (Corning® IRIS® glass), a solvent-based polymer material (comp “D”) and composition “A” at a position 320 mm from the light injection edge surface of the coated glass sample as a function of aging time at a temperature of 60° C. and 90% relative humidity. The data show very little additional color shift difference between the bare glass and the glass samples coated with the composition “A” polymer material. On the other hand, the solvent-based polymer coating (comp “D”) shows a significant increase in color shift.

It will be apparent to those skilled in the art that various modifications and variations can be made to embodiments of the present disclosure without departing from the spirit and scope of the disclosure. Thus it is intended that the present disclosure cover such modifications and variations provided they come within the scope of the appended claims and their equivalents.

1. A backlight unit, comprising:
a glass substrate comprising a first major surface and a second major surface opposite the first major surface;
a cured polymer layer disposed on the first major surface, the cured polymer layer comprising a pencil hardness value in a range from 1 H to 2 H as measured in accordance with ASTM D3363-05 and an adhesion of 5 B as measured in accordance with ASTM D3359-09; and
wherein a maximum color shift Δy_{Cmax} of the cured polymer layer over a wavelength range from 380 nm to 780 nm is equal to or less than about 0.015 after aging of the cured polymer layer for 1000 hours at 60° C. and 90% relative humidity.

2. The backlight unit according to claim 1, wherein the cured polymer layer comprises a dual-cure polymer material.

3. The backlight unit according to claim 2, wherein the dual-cure polymer material comprises a free radical-curing acrylate and a cationic-curing epoxy.

4. The backlight unit according to claim 1, wherein Δy_{Cmax} after the aging is less than about 0.01.

5. The backlight unit according to claim 1, wherein the cured polymer layer comprises a plurality of microstructures arranged in rows.

6. The backlight unit according to claim 1, wherein a thickness of the glass substrate is in a range from about 0.1 mm to about 3 mm.

7. The backlight unit according to claim 1, wherein a maximum thickness of the cured polymer layer is in a range from about 10 μm to about 500 μm.

8. The backlight unit according to claim 1, further comprising a plurality of light extraction features on the second major surface.

9. The backlight unit according to claim 8, wherein a spatial density of the plurality of light extraction features varies in a length direction of the glass substrate.

10. The backlight unit according to claim 9, wherein the spatial density increases in a direction away from a light injection edge surface of the glass substrate.

11. The backlight unit according to claim 1, wherein the backlight unit comprises a display device.

12. A backlight unit, comprising:
a glass substrate including a first major surface and a second major surface opposite the first major surface;
a cured polymer layer disposed on the first major surface, the cured polymer layer comprising a pencil hardness value in a range from 1 H to 2 H as measured in accordance with ASTM D3363-05 and an adhesion of 5 B as measured in accordance with ASTM D3359-09, the cured polymer layer further comprising a plurality of microstructures arranged in rows; and
wherein a maximum color shift Δy_{Cmax}, of the cured polymer layer over a wavelength range from 380 nm to 780 nm is equal to or less than about 0.015 after aging for 1000 hours at 60° C. and 90% relative humidity.

13. The backlight unit according to claim 12, wherein the cured polymer layer comprises a dual-cure polymer material.

14. The backlight unit according to claim 13, wherein the dual-cure polymer material comprises a free radical-curing acrylate and a cationic-curing epoxy.

15. The backlight unit according to claim 12, wherein the rows are parallel rows.

16. The backlight unit according to claim 12, wherein the second major surface comprises a plurality of light extraction features.

17. The backlight unit according to claim 16, wherein a spatial density of the light extraction features varies in a length direction of the glass substrate.

18. The backlight unit according to claim 17, wherein the spatial density increases in a direction away from a light injection edge surface of the glass substrate.

19. The backlight unit according to claim 12, wherein the backlight unit comprises a display device.

20. The backlight unit according to claim 12, wherein a thickness of the glass substrate is in a range from about 0.1 mm to about 3 mm.

21.-28. (canceled)
